(19) United States
(12) Patent Application Publication
(10) Pub. No.: US 2026/0247112 A1
(43) Pub. Date: Aug. 20, 2026

(54) NETWORK NODE AND METHOD IN A WIRELESS COMMUNICATIONS NETWORK

(71) Applicant: Telefonaktiebolaget LM Ericsson (publ), Stockholm (SE)

(72) Inventors: Saad Naveed AHMED, SUNDBYBERG (SE); Tomas SVADLING, Hammarö (SE); Ola LUNDQVIST, KARLSTAD (SE)

(21) Appl. No.: 19/162,464

(22) PCT Filed: Mar. 14, 2023
(86) PCT No.: PCT/SE2023/050227

§ 371 Date: Sep. 5, 2025

(51) Int. Cl. H04W 4/06; H04L 5/00

(52) U.S. Cl. CPC H04W 4/06; H04L 5/0048

(57) ABSTRACT

A method performed by a network node is provided. The method is for handling a Category M, Cat-M, User Equipment, UE, in relation to a subframe configuration in a wireless communications network. The subframe configuration is a Multicast-Broadcast Single-Frequency Network, MBSFN, subframe configuration configured for operating in a first Radio Access technology, RAT, and a second RAT. The subframe configuration comprising a first MBSFN pattern. The network node broadcasts (302) information about the first MBSFN pattern in a second RAT cell, to a second RAT UE and the Cat-M UE which is of the second RAT. When the network node obtains (303) an updated subframe configuration comprising an updated MBSFN pattern: The network node refrains (304) from broadcasting information about the updated MBSFN pattern to the Cat-M UE and continues (305) to broadcast information about the first MBSFN pattern in the second RAT cell to the Cat-M UE. The network node transmits (307) in the second RAT cell, second RAT CRS on the at least one Port in the updated MBSFN pattern for the Cat-M UE to use.

### TECHNICAL FIELD

Embodiments herein relate to a network node and methods therein. In some aspects, they relate to handling a Category M (Cat-M) User Equipment (UE) in relation to a subframe configuration in a wireless communications network.

Embodiments herein further relates to computer programs and carriers corresponding to the above methods and network node.

### BACKGROUND

In a typical wireless communication network, wireless devices, also known as wireless communication devices, mobile stations, stations (STA) and/or User Equipment (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G). A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR) or Next Generation (NG). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

### Dynamic Spectrum Sharing

A Dynamic Spectrum Sharing (DSS) gives a possibility to introduce and add 5G within existing 4G carriers. It can support NR, LTE, Category M (Cat-M) and Narrowband Internet of things (NB-IoT) technologies simultaneously. Cat-M is a Low Power Wide Area (LPWA) technology designed to support Massive IoT, i.e. billions of IoT devices, with cellular technologies. NB-IoT is a LPWA network radio technology standard developed by 3GPP for cellular devices and services. DSS introduces intelligent, flexible, and quick 5G on low and/or mid bands for wide area coverage without impacting LTE. In DSS the spectrum may be dynamically shared between 4G and 5G carriers based on traffic demand. The switch between carriers happens within milliseconds, which minimizes spectrum wastage and allows for best end-user performance.

FIG. 1 depicts an example of LTE and NR sharing a spectrum in time and frequency, wherein the LTE part of the carriers is represented by white staples in the bottom of the figure, and the NR part of the carriers is represented by black staples in the top of the FIG.

### CAT-M

3GPP Release 13 defines UE Category M1, also referred to as Cat-M, targeting low-cost chipsets, and introduces support for coverage enhancement. Category M1 UEs are fundamentally different from UEs of other types: they are optimized for massive IoT deployments. In a specific subframe, a Category M1 UE can only receive radio signals on one narrowband. Each narrowband comprises six contiguous Physical Resource Blocks (PRBs), at a 3GPP defined location and only depends on the LTE cell bandwidth.

### Dynamic MBSFN

In WO2021225484 a method relating to dynamic MBSFN configuration in Spectrum Sharing RATs, is described. The method relates to exchanging LTE capacity with NR capacity and vice versa by use of Dynamic MBSFN. However, from the perspective of a Cat-M UE, MBSFN subframes are considered invalid. After changes are applied to the configuration of MBSFN subframes, all CAT-M UEs that are in connected mode are forced to release to acquire new or reacquire System Information Block (SIB) 1-BR.

### LTE CRS Rate-Matching

To avoid the LTE Cell-specific Reference Signal (CRS) resource elements (RE), a 5G-NR UE may be configured with the LTE CRS RE information so that an NR UE can calculate the LTE CRS REs as reserved unavailable resources, referred to as LTE CRS rate matching.

Rate-matching in this context means to regard certain resource elements as unavailable for Physical Downlink Shared Channel (PDSCH).

An NR device, such as an NR UE, that is configured with LTE CRS rate matching is aware of the resource elements in the time-frequency grid of the shared spectrum carrying LTE CRS and it does not decode NR data on these resource elements. CRS rate matching is available for an NR data channel when using 15 kHz subcarrier spacing with both Frequency Division Duplex (FDD) and Time Division Duplex (TDD).

### SUMMARY

As a part of developing embodiments herein the inventors identified a problem which first will be discussed.

Dynamic update of MBSFN have the following negative impacts on Cat-M UE's and the operation of the system:
Connected Cat-M UE's need to re-connect when MBSFN is updated. If an MBSFN pattern is updated very often this will have a negative impact on Cat-M service.
A Cat-M UE in Extended Discontinuous Reception (E-DRX) is very likely to be in sleep mode during MBSFN updates and they will not get informed about the new MBSFN pattern. They will then not be aligned with eNB of what MBSFN pattern to use. This will in turn result in that network-initiated access no longer possible until the Cat-M UE re-reads the MBSFN pattern on their own initiative.
A maximum dynamic MBSFN must be limited to 50% for LTE UEs since that is the maximum MBSFN ratio Cat-M UE's can support in practice due to the combination of Cat-M using MTC Physical Downlink Control Channel (MPDCCH) and PDSCH repetitions and is limited to half-duplex.

An object of embodiments herein is to improve the performance in a multi-RAT wireless communications network.

According to an aspect, the object is achieved by a method performed by a network node. The method is for handling a Category M, Cat-M, User Equipment, UE, in relation to a subframe configuration in a wireless communications network. The subframe configuration is a Multicast-Broadcast Single-Frequency Network, MBSFN, subframe configuration configured for operating in a first Radio Access technology, RAT, and a second RAT. The subframe configuration comprises a first MBSFN pattern. The network node configures a first RAT UE with the first MBSFN pattern and to perform rate-matching around at least one Cell-specific Reference Signal, CRS, Port of the second RAT in all subframes that are not part of the first MBSFN pattern. The network node broadcasts information about the first MBSFN pattern in a second RAT cell, to a second RAT UE and the Cat-M UE which is of the second RAT. When the network node obtains an updated subframe configuration comprising an updated MBSFN pattern: The network node refrains from broadcasting information about the updated MBSFN pattern to the Cat-M UE, and continues to broadcast information about the first MBSFN pattern in the second RAT cell to the Cat-M UE. The network node broadcasts in the second RAT cell, information about the updated MBSFN pattern to the second UE. The network node transmits in the second RAT cell, second RAT CRS on the at least one Port in the updated MBSFN pattern for the Cat-M UE to use.

According to another aspect, the object is achieved by a network node configured to handling a Category M, Cat-M, User Equipment, UE, in relation to a subframe configuration in a wireless communications network. The subframe configuration is adapted to be a Multicast-Broadcast Single-Frequency Network, MBSFN, subframe configuration configured for operating in a first Radio Access technology, RAT, and a second RAT. The subframe configuration is adapted to comprise a first MBSFN pattern. The network node is further configured to:
Configure a first RAT UE with the first MBSFN pattern and to perform rate-matching around at least one Cell-specific Reference Signal, CRS, Port of the second RAT in all subframes that are not part of the first MBSFN pattern,
broadcast information about the first MBSFN pattern in a second RAT cell, to a second RAT UE and the Cat-M UE which is of the second RAT,
when obtaining an updated subframe configuration comprising an updated MBSFN pattern:
refrain from broadcasting information about the updated MBSFN pattern to the Cat-M UE, and continue to broadcast information about the first MBSFN pattern in the second RAT cell to the Cat-M UE,
broadcast in the second RAT cell, information about the updated MBSFN pattern to the second UE, and
transmit in the second RAT cell, second RAT CRS on the at least one Port in the updated MBSFN pattern for the Cat-M UE to use.

Advantages of embodiments herein at least comprises:

To refrain from broadcasting information about the updated MBSFN pattern to the Cat-M UE, and continue to broadcast information about the first MBSFN pattern in the second RAT cell to the Cat-M UE gives the following advantages:
To refrain from informing the Cat-M UE with the updated MBSFN pattern, does not impact on Cat-M service since MBSFN update have big impact on Cat-M devices, it forces Cat-M devices to re-connect to the network to acquire the updated MBSFN pattern, in turn impacting Cat-M service and increase Cat-M RRC signaling load.
The problem with e-DRX for the Cat-M UE is overcome. e-DRX is very tricky to co-exist with updated MBSFN since Cat-M UE can be in e-DRX sleep during update phase and MBSFN pattern will then not align between eNB and Cat-M UE's.
An increase of up to maximum no of MBSFN can now be used.

### BRIEF DESCRIPTION OF THE DRAWINGS

FIG. 1 is a schematic block diagram depicting an example of prior art.

FIG. 2 is a schematic block diagram depicting embodiments of a wireless communication network.

FIG. 3 is a flow chart depicting embodiments of a method in a network node.

FIG. 4 is a schematic block diagram depicting some embodiments.

FIG. 5 is a schematic block diagram depicting an example embodiment.

FIG. 6 is a schematic sequence diagram depicting an example embodiment of a method.

FIG. 7 is a schematic block diagram depicting embodiments of a network node.

FIG. 8 schematically illustrates a telecommunication network connected via an intermediate network to a host computer.

FIG. 9 is a generalized block diagram of a host computer communicating via a base station with a user equipment over a partially wireless connection.

FIGS. 10 to 13 are flowcharts illustrating methods implemented in a communication system including a host computer, a base station and a user equipment.

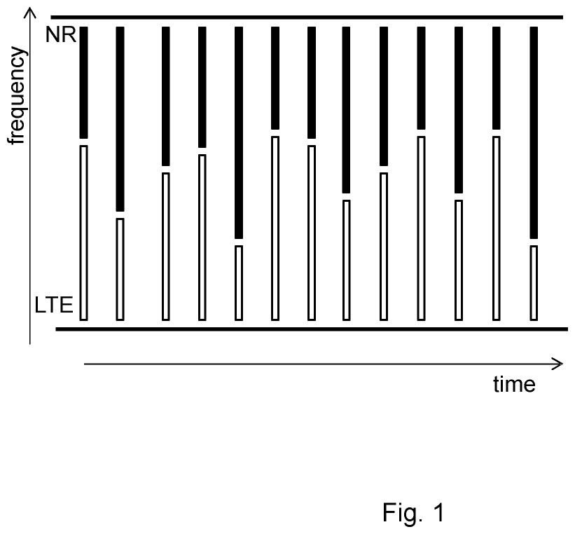

### DETAILED DESCRIPTION

Embodiments herein e.g., relate to Cat-M UE coexistence in Dynamic MBSFN.

An example of a method according to embodiments herein comprises the following actions:

A network node configures UEs of a first RAT, e.g., NR UEs, to perform rate-matching around at least one Cell-specific Reference Signal (CRS) Port of a second RAT e.g., around at least LTE CRS Port 0, in all subframes.

When an MBSFN subframe configuration with a new MBSFN pattern must be changed, the network node does not update Cat-M UEs with the new MBSFN pattern.

The network node continues to transmit CRS Port of a second RAT, such as e.g., LTE CRS Port 0, in the updated dynamically added MBSFN subframes for the second RAT, e.g., LTE. The wording “dynamically added MBSFN subframes” when used herein e.g., means that the MBSFN subframe configuration is updated so that the number of MBSFN subframes increase relative to previous MBSFN subframe configuration.

In case an enhanced Multimedia Broadcast/Multicast Service (eMBMS) service must be transmitted in MBSFN subframes, the network node punctures the PDSCH REs that overlap with Port 0 CRS.

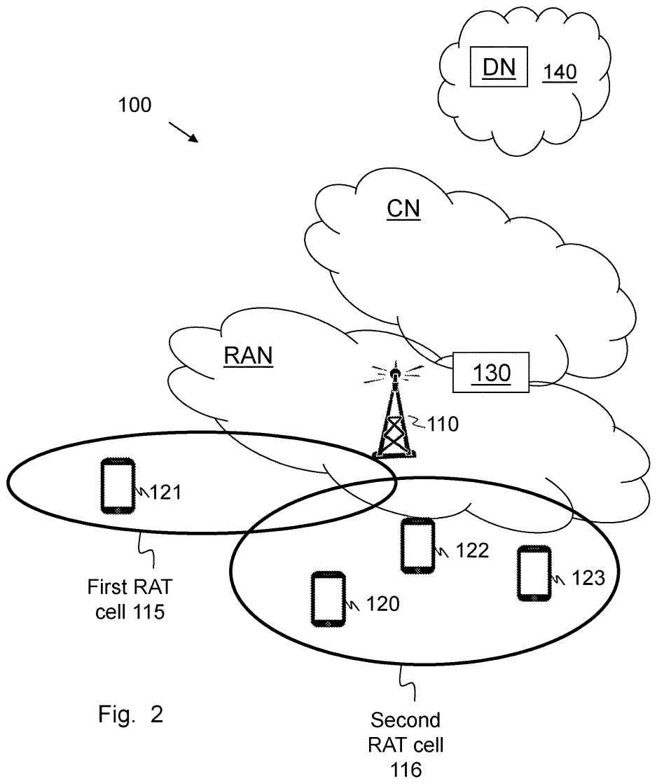

FIG. 2 is a schematic overview depicting a wireless communications network 100 wherein embodiments herein may be implemented. The wireless communications network 100 comprises one or more RANs and one or more CNs. The wireless communications network 100 may use Fifth Generation New Radio, (5G NR) but may further use a number of other different Radio Access Technologies (RAT)s, such as, Wi-Fi, LTE, LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a network node 110, operate in the wireless communications network 100. The network node 110 is configured to operate in a first RAT and a second RAT. The first RAT may be represented by 5G NR and the second RAT may be represented by LTE. The network node 110 provides radio access in one or more cells such as e.g., a first RAT cell 115 and a second RAT cell 116. The first RAT cell 115 may not be present in non-spectrum sharing mode. The network node 110 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within the cell served by network node 110 depending e.g. on the radio access technology and terminology used.

Wireless devices such as a Cat-M UE 120, a first RAT UE 121, a second RAT UE 122 and an eMBMS UE 123 operate in the wireless communications network 100. The Cat-M UE 120 and the eMBMS UE 123 are of the second RAT. An eMBMS UE when used herein means a device that can run eMBMS service.

The respective UE 121, 122, 123 may e.g. be an NR device, a mobile station, a wireless terminal, an NB-IoT device, an eMTC device, a CAT-M device, a WiFi device, an LTE device and an a non-access point (non-AP) STA, a STA, that communicates via a base station such as e.g. the network node 110, one or more Access Networks (AN), e.g. RAN, to one or more CNs. It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

According to some embodiments herein second RAT eMBMS functions operate in the wireless communications network. The second RAT eMBMS functions provides services to the eMBMS UE 123. A second RAT eMBMS function when used herein e.g., means a point-to-multipoint service in which data is transmitted from a single source entity to multiple recipients which can be used for file download and for streaming services, for example mobile television.

According to some but not limiting embodiments herein, a first RAT may e.g., be any one out of LTE or NR. A second RAT may e.g., be LTE if the first RAT is NR, or NR if the first RAT is LTE.

Methods herein may be performed by the network node 110. As an alternative, a Distributed Node (DN) and functionality, e.g. comprised in a cloud 140 as shown in FIG. 2, may be used for performing or partly performing the methods.

According to example embodiments herein, updated subframe configuration comprising MBSFN updates are signaled to second RAT, e.g., LTE, UE's only. Cat-M and First RAT, e.g., NR, MBSFN pattern are configured to be static. CRS Port 0 transmissions are sent in the MBSFN subframes according to the updated subframe configuration to secure Cat-M synchronization with network, Channel Quality Information (CQI) and Channel Estimation. PDSCH is punctured of eMBMS overlapping with Port 0 CRS.

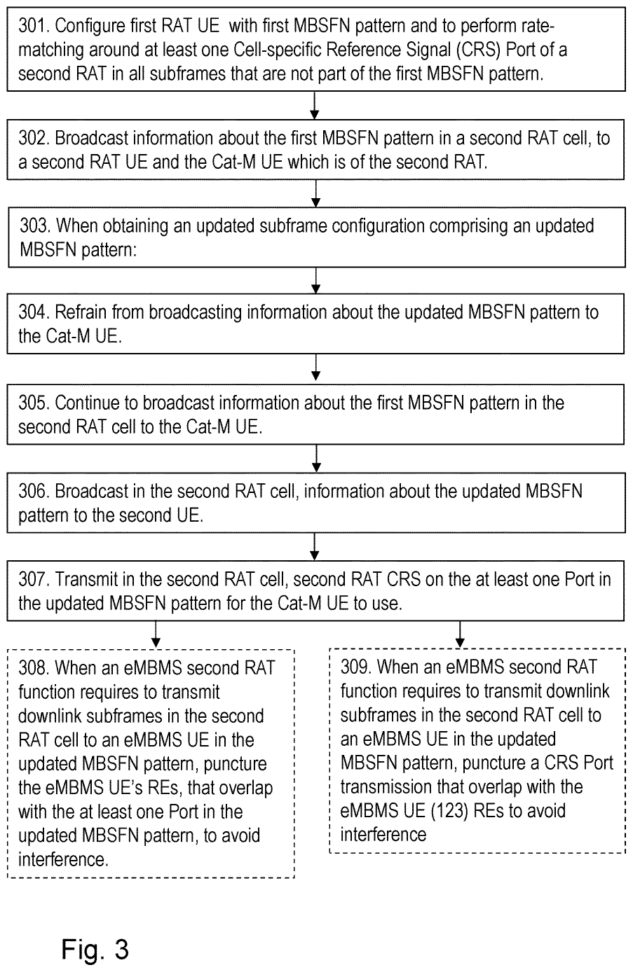

FIG. 3 shows example embodiments of a method performed by a network node 110. The method is for handling the Cat-M UE 120 in relation to a subframe configuration in the wireless communications network 100. This is e.g., to enable and improve the Cat-M UE 120 coexistence in dynamic MBSFN. The subframe configuration is an MBSFN subframe configuration configured for operating in a first RAT and a second RAT. It may e.g., be configured to operate in spectrum sharing mode or non-spectrum sharing mode. The first RAT may e.g., be represented by 5G NR and the second RAT may e.g., be represented by LTE. The subframe configuration comprises a first MBSFN pattern. An MBSFN pattern when used herein e.g., means the pattern of MBSFN subframes repeated with certain periodicity. The word “first” in the “first MBSFN pattern” is only used as a name to differentiate it from a later on updated MBSFN pattern.

The method comprises one or more of the following actions, which actions may be taken in any suitable order. Actions that are optional are marked with dashed boxes in the figure.

### Action 301

The network node 110 configures the first RAT UE 121 with the first MBSFN pattern. The network node 110 further configures the first RAT UE 121 to perform rate-matching around at least one CRS Port of the second RAT in all subframes. This latter is an advantage since the network node 110 will later on 110 transmit second RAT CRS on the at least one Port in the updated MBSFN pattern for the Cat-M UE 120 to use in the second RAT cell 116. The first RAT UE 121 will then regard the resource elements corresponding to the at least one CRS Port of the second RAT in all subframes as unavailable for PDSCH and not use them.

This action may be performed upon detecting that the first RAT UE 121, e.g. the NR UE 121, is capable of second RAT, e.g., LTE,-CRS rate-matching.

This action may be performed by the network node 110 in the first RAT cell 115, e.g. the NR cell 115.

### Action 302

The network node 110 broadcasts information about the first MBSFN pattern in a second RAT cell 116, to a second RAT UE 122 and the CAT-M UE 120. The Cat-M UE 120 is of the second RAT, e.g., referred to as a second RAT Cat-M UE. This may mean that the information is broadcasted to be received by any zero or more second RAT UEs, but is in this example scenario received by the second RAT UE 122 and the Cat-M UE 120.

In some embodiments, different fields are used for configuring the second RAT UE 122, and the Cat-M UE 120. For the second RAT such as e.g. LTE, it may be the MBSFN-Subframe Configuration (mbsfn-SubframeConfigList) parameter is optional in SIB2 and may be used by LTE UEs, while for the Cat-M UE 120 fdd-DownlinkOrTddSubframeBitmapBR may be used in SIB1-BR transmissions optional and is overriding MBSFN-SubframeConfig from an UE perspective. It may optionally be used in SIB1 and is used by a UE to update mbsfn-SubframeConfigList.

### Action 303

In an example scenario an MBSFN pattern needs to be updated from time to time. This may e.g. be when NR RAT or eMBMS service requires more dedicated subframes or LTE RAT is in energy saving mode. This may be performed in non-spectrum sharing mode by LTE RAT, and in spectrum sharing mode by Shared Resource Allocator. The LTE may perform the updating. When the network node 110 obtains an updated subframe configuration comprising an updated MBSFN pattern, the network node 110 performs the following actions 304-307:

The Cat-M UE may be in any state such as not in e-DRX sleep, however, according to embodiments herein, the Cat-M UE 120 is enabled to be in e-DRX sleep, e.g., when obtaining an updated subframe configuration and/or during an MBSFN pattern updating phase thereafter.

### Action 304

The network node 110 refrains from broadcasting information about the updated MBSFN pattern to the Cat-M UE 120.

To refrain from informing the Cat-M UE 120 with the updated MBSFN pattern gives the benefit of no degradation on on-going Cat-M service; no synchronization issue for e-DRX sleep CAT-M UEs, e.g. the CAT-M UE 120, and maximum number of MBSFN subframes may be used by network.

### Action 305

The network node 110 continues to broadcast information about the first MBSFN pattern in the second RAT cell 116 to the Cat-M UE 120.

This is an excellent advantage since the Cat-M UE 120 can, or may, be in e-DRX sleep without being unsynchronized with the Cat-M UE's 120 used first MBSFN pattern. There is no degradation on on-going Cat-M service; and the maximum number of MBSFN subframes can be used by network.

### Action 306

The network node 110 broadcasts in the second RAT cell 116, information about the updated MBSFN pattern to the second UE 122. In this way the second RAT UE 122 is updated but not the Cat-M UE 120.

### Action 307

The network node 110 transmits in the second RAT cell 116, second RAT CRS on the at least one Port in the updated MBSFN pattern for the Cat-M UE 120 to use. This transmitting may thus be performed in order to ensure Cat-M CQI and Channel Estimation uninterrupted service continuity, and/or synchronization. As mentioned above, the first RAT UE 121 is configured to perform rate-matching around the at least one CRS Port of the second RAT in all subframes. This is e.g., to ensure First RAT such as NR RAT functions without problem.

### Action 308

In some embodiments, when an enhanced eMBMS second RAT function requires to transmit downlink subframes in the second RAT cell 116 to an eMBMS UE 123 in the updated MBSFN pattern, the network node 110 punctures an eMBMS UE's 123 Resource Elements, REs, that overlap with the at least one Port in the updated MBSFN pattern. This is to avoid interference, e.g., to Cat-M service. This may happen when maintaining Cat-M service performance is more important than eMBMS service performance.

### Action 309

In some other embodiments, as an alternative to Action 308, when an eMBMS, second RAT function requires to transmit downlink subframes in the second RAT cell 116 to an eMBMS UE 123 in the updated MBSFN pattern, the network node 110 punctures a CRS Port transmission that overlap with the eMBMS UE 123 REs to avoid interference, e.g. to eMBMS service.

The embodiments described above will now be further explained and exemplified. The example embodiments described below may be combined with any suitable embodiment above.

In an example embodiment of the method, the following steps are performed. In this example, the first RAT may be represented by 5G NR and the second RAT may be represented by LTE.

The system configures NR UEs such as the first RAT UE 121, to rate match at least around LTE CRS Port 0.

When the network node obtains the updated subframe configuration, such as e.g., a new suitable MBSFN pattern, it is signaled to LTE UEs, such as the second UE 122, e.g. in SystemInformationBlockType2 (SIB2).

Cat-M UEs, such as the Cat-M UE 120, are not informed about the new MBSFN pattern, also referred to as the updated MBSFN pattern, they keep the static configured MBSFN pattern, also referred to as the first MBSFN pattern, as transmitted at setup.

The network node 110 continues to transmit CRS on Port 0 in the LTE cell such as the second RAT cell 116, in the additional dynamically added MBSFN subframes, i.e., the subframes according to the updated MBSFN pattern for LTE. These are for the Cat-M UE 120 to use.

If an eMBMS service needs to transmit PDSCH in newly added MBSFN subframes, its PDSCH REs that overlap with Port 0 CRS, are punctured to avoid interfering with each other.

As mentioned above CAT-M UEs such as the Cat-M UE 120 will not dynamically update the MBSFN pattern. When the Cat-M UE 120 is in e-DRX, it may not even access the RAN with updated MBSFN. The network node 110 continues transmitting Port0 CRS even in MBSFN subframes for CAT-M UEs, such as the Cat-M UE 120, and refrains from updating the MBSFN pattern.

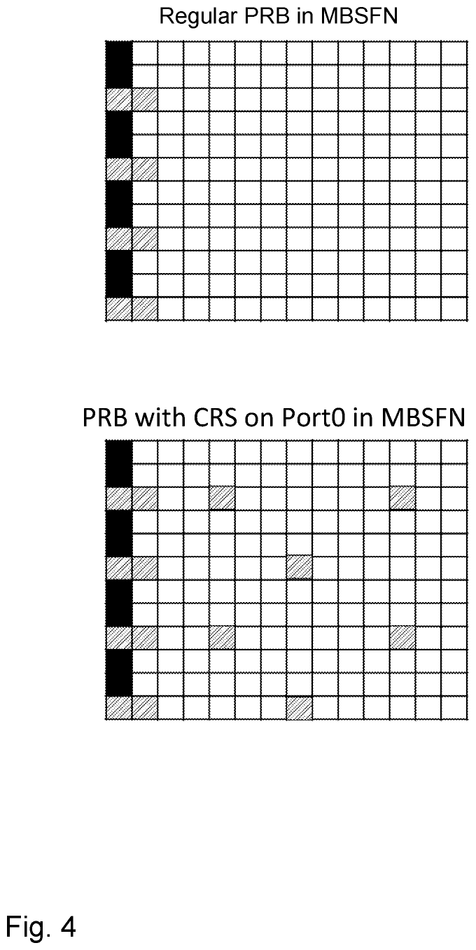

FIG. 4 depicts CRS REs in a time-frequency PRB according to embodiments herein. The black boxes in FIG. 4 represent REs that are not CRS and may be either LTE's Physical Control Format Indicator Channel (PCFICH), Physical channel Hybrid ARQ Indicator Channel (PHICH), PDCCH or NR's PDCCH, PDSCH etc. The diagonally striped boxes represent REs that are CRS. The top diagram of FIG. 4 depicts Regular PRB in MBSFN for 4 CRS Ports. The bottom diagram of FIG. 4 depicts a PRB with CRS on Port0 in MBSFN for 4 CRS Ports. From FIG. 4 it can be seen that additional CRS REs are transmitted on Port0 in dynamically added MBSFN subframe.

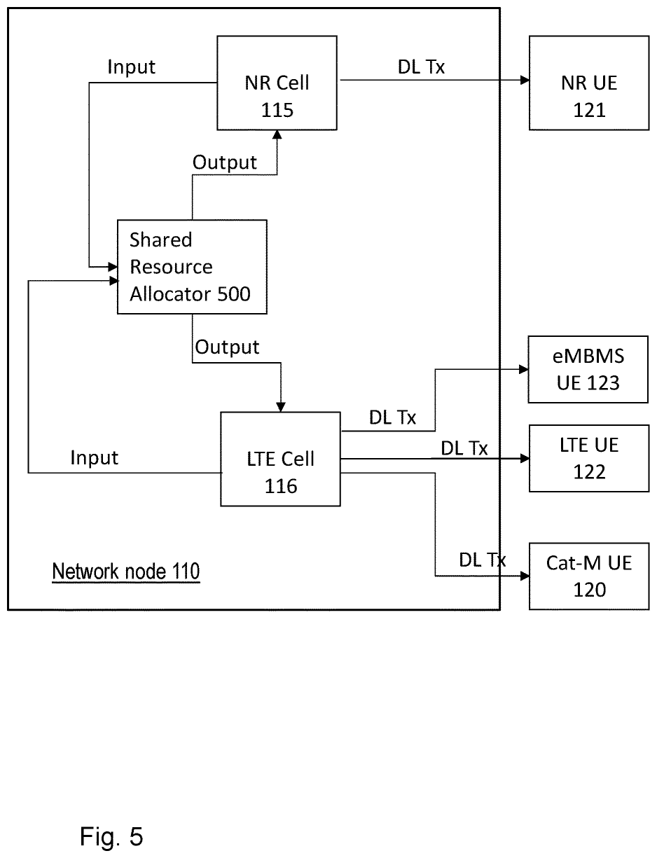

FIG. 5 is a block diagram depicting an arrangement of the network node 110, the Cat-M UE 120, the first RAN UE 121 represented by an NR UE and the second RAN UE 122 represented by an LTE UE, according to an example of embodiments herein. The network node 110 may comprise a shared resource allocator 500 for allocating resource blocks for transmissions, such as Downlink (DL) transmissions (Tx) according to embodiments herein. From FIG. 5 it can be seen that each RAT reports its resource needs to the shared resource allocator 500 which then distributes resources between them. These resources are further scheduled to each UE.

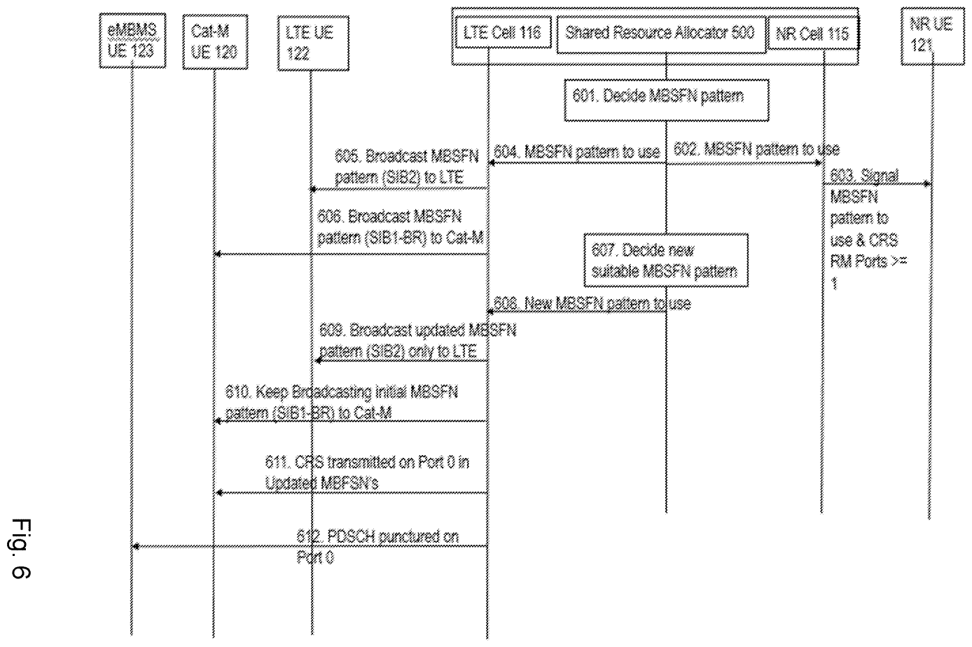

FIG. 6 is a sequence diagram depicting an example of the method performed by the network node 110, comprising the following actions.

The network node 110, such as its shared resource allocator 500 decides 601 a first MBSFN pattern to be used.

The first MBSFN pattern to use and also CRS RM Ports>=1 is signalled 602, 603 to the first RAT UE in the first RAT cell 115. This is related to and may be combined with Action 301 described above.

The first MBSFN pattern to use is Broadcasted e.g. in (SIB2) to the second RAT UE 122 604, 605 and broadcast to the Cat-M UE 120 e.g., in SIB1-BR 606. This is related to and may be combined with Action 302 described above.

The network node 110, such as its shared resource allocator 500 decides, also referred to as obtains 607 new suitable, such as an updated MBSFN pattern to be used. This is related to and may be combined with Action 603 described above.

The updated MBSFN patten to use is broadcasted e.g. in (SIB2) only to the second RAT UE 122 608, 609 and keeps broadcasting the first MBFSN to the Cat-M UE 120 e.g., in SIB1-BR 610. This is related to and may be combined with Actions 304-306 described above.

The network node 110 transmits CRS on Port 0 in updated MBFSN's to be used by the Cat-M UE 120, 611. This is related to and may be combined with Action 307 described above.

In some embodiments, the network node 110 transmits PDSCH punctured on Port 0 to the eMBMS UE 123 612. This is related to and may be combined with Actions 308 and 309 described above.

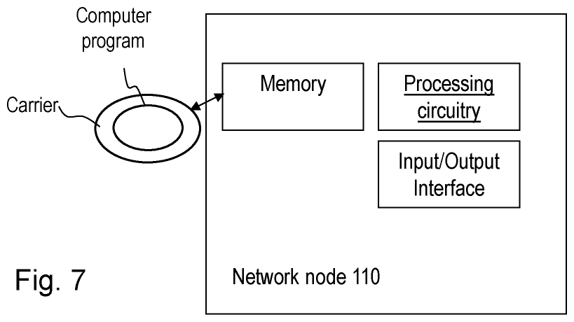

To perform the action as mentioned above, the network node 110 may comprise the arrangement as shown in FIG. 7.

The network node 110 may comprise a respective input and output interface configured to communicate with the UEs 120, 121, 122 and 23. The input and output interface may comprise a wireless receiver (not shown) and a wireless transmitter (not shown).

The network node 110 is configured to handling the Cat-M UE 120 in relation to a subframe configuration in the wireless communications network 100. The subframe configuration is adapted to be a MBSFN subframe configuration configured for operating in the first RAT and the second RAT. The subframe configuration is adapted to comprise a first MBSFN pattern.

The network node 110 further being configured to configure a first RAT UE 121 with the first MBSFN pattern and to perform rate-matching around at least one Cell-specific Reference Signal, CRS, Port of the second RAT in all subframes that are not part of the first MBSFN pattern,

The network node 110 further being configured to broadcast information about the first MBSFN pattern in a second RAT cell 116, to a second RAT UE 122 and the Cat-M UE 120 which is of the second RAT,

The network node 110 further being configured to, when obtaining an updated subframe configuration comprising an updated MBSFN pattern:
refrain from broadcasting information about the updated MBSFN pattern to the Cat-M UE 120, and continue to broadcast information about the first MBSFN pattern in the second RAT cell 116 to the Cat-M UE 120,
broadcast in the second RAT cell 116, information about the updated MBSFN pattern to the second UE 122, and
transmit in the second RAT cell 116, second RAT CRS on the at least one Port in the updated MBSFN pattern for the Cat-M UE 120 to use.

In some embodiments, the network node 110 is further being configured to, when an eMBMS second RAT function requires to transmit downlink subframes in the second RAT cell 116 to an eMBMS UE 123 in the updated MBSFN pattern, puncture an eMBMS UE's 123 REs that overlap with the at least one Port in the updated MBSFN pattern, to avoid interference.

In some other embodiments, the network node 110 is further being configured to, when an eMBMS second RAT function requires to transmit downlink subframes in the second RAT cell 116 to an eMBMS UE 123 in the updated MBSFN pattern, puncture a CRS Port transmission that overlap with the eMBMS UE 123 REs to avoid interference.

The network node 110 may further be configured to transmit in the second RAT cell 116, the second RAT CRS on the at least one Port in the updated MBSFN pattern for the Cat-M UE 120 to use, in order to ensure Cat-M CQI and Channel Estimation.

The Cat-M UE 120 may be adapted to be in e-DRX sleep.

The first RAT may be adapted to be represented by 5G NR, and the second RAT may be adapted to be represented by LTE.

The embodiments herein may be implemented through a respective processor or one or more processors, such as the respective processor of a processing circuitry in the network node 110, depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a respective memory comprising one or more memory units. Each memory comprises instructions executable by the processor in the network node 110.

Each respective memory is arranged to be used to store requirements, evaluations, information, data, configurations, and applications to perform the methods herein when being executed in the network node 110.

In some embodiments, a respective computer program comprises instructions, which when executed by the at least one processor, cause the at least one processor of the network node 110 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units in the units described above may refer to a combination of analog and digital circuits, and/or one or more processors configured with software and/or firmware, e.g. stored in the network node 110, that when executed by the respective one or more processors such as the processors or processor circuitry described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### Further Extensions and Variations

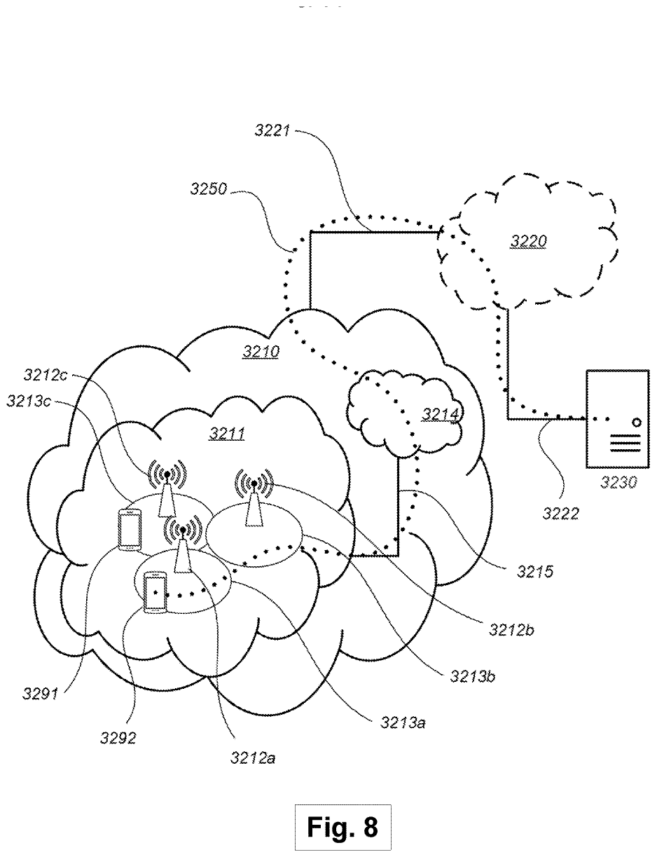

With reference to FIG. 8, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

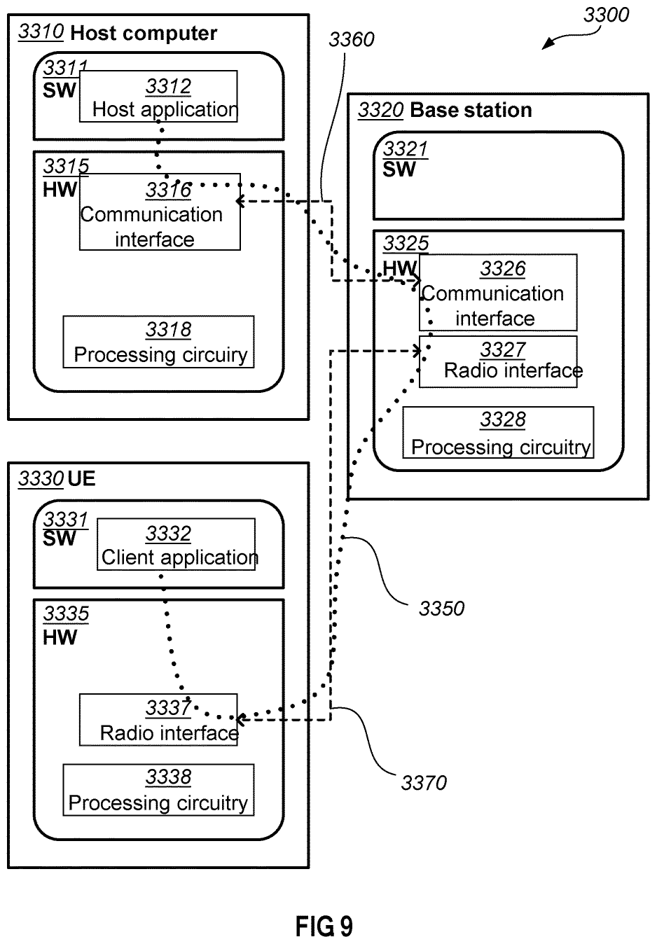

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

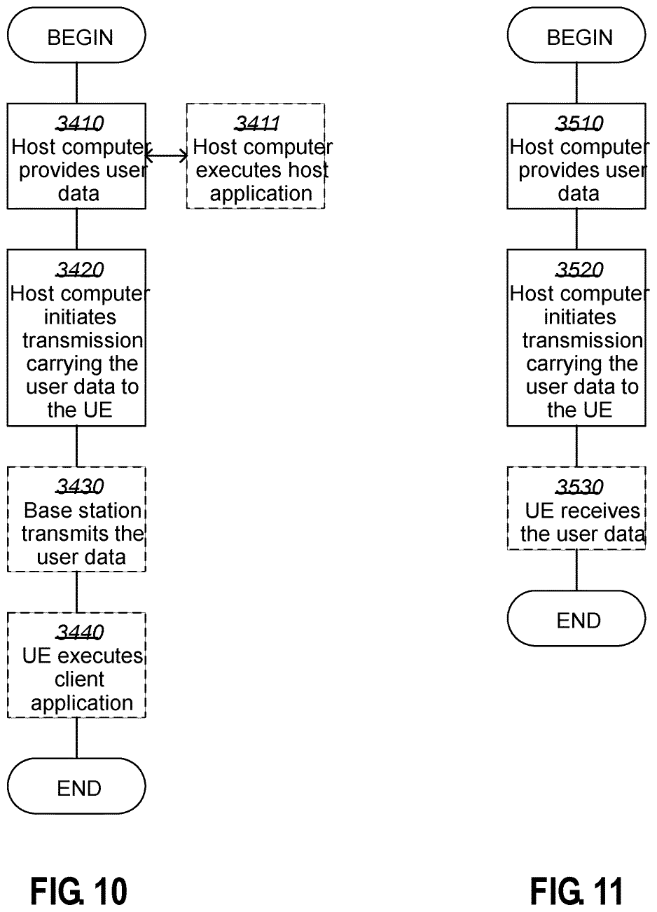

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 10, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 10 is a flowchart illustrating a method implemented in a communication system, in accordance with one embodiment. The communication system includes a host computer, a base station such as the network node 110, and a UE such as the UE 120, which may be those described with reference to FIG. 8 and FIG. 9. For simplicity of the present disclosure, only drawing references to FIG. 10 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 11 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

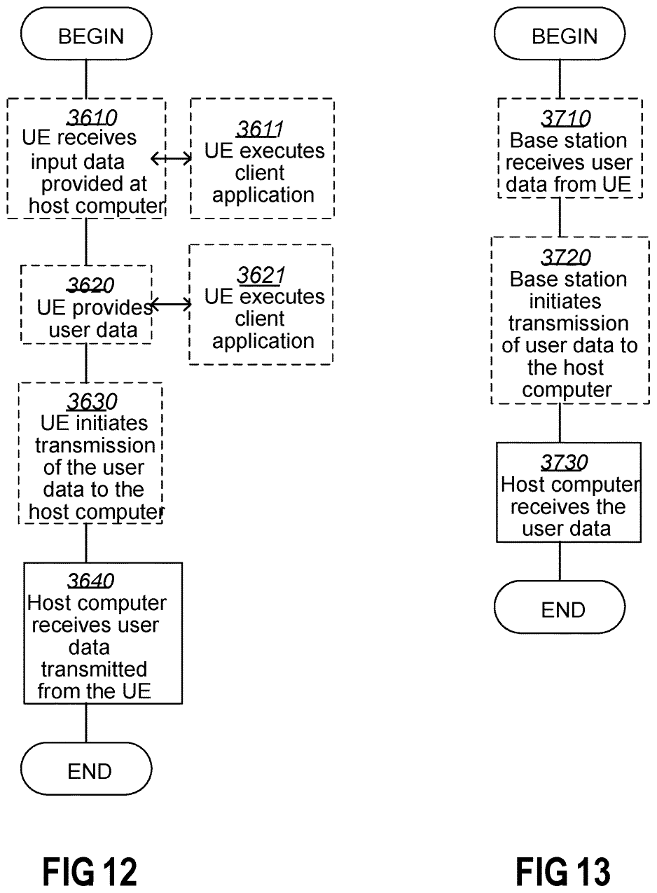

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 12 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 13 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

### Abbreviation Explanation

BW Band Width
CRS Cell Reference Signal
DCI Downlink Control Information
DL Down Link
PRB Physical Resource Block
RE Resource Elements
RM Rate Match
RRC Radio Resource Control
RSRP Reference Signal Received Power
TX Transmit
UE User Equipment

1. A method performed by a network node for handling a Category M (Cat-M), User Equipment (UE) in relation to a subframe configuration in a wireless communications network, which subframe configuration is a Multicast-Broadcast Single-Frequency Network (MBSFN) subframe configuration configured for operating in a first Radio Access technology, (RAT) and a second RAT, and which subframe configuration comprises a first MBSFN pattern, the method comprising:
configuring a first RAT UE with the first MBSFN pattern and to perform rate-matching around at least one Cell-specific Reference Signal (CSR), Port of the second RAT in all subframes that are not part of the first MBSFN pattern,
broadcasting information about the first MBSFN pattern in a second RAT cell, to a second RAT UE and the Cat-M UE which is of the second RAT,
when obtaining an updated subframe configuration comprising an updated MBSFN pattern:
refraining from broadcasting information about the updated MBSFN pattern to the Cat-M UE, and continuing to broadcast information about the first MBSFN pattern in the second RAT cell to the Cat-M UE,
broadcasting in the second RAT cell, information about the updated MBSFN pattern to the second UE, and
transmitting in the second RAT cell, second RAT CRS on the at least one Port in the updated MBSFN pattern for the Cat-M UE to use.

2. The method according to claim 1, further comprising:
when an enhanced Multimedia Broadcast/Multicast Service, eMBMS, of the second RAT function requires to transmit downlink subframes in the second RAT cell to an eMBMS UE in the updated MBSFN pattern, puncturing the eMBMS UE's Resource Elements, REs, that overlap with the at least one Port in the updated MBSFN pattern, to avoid interference.

3. The method according to claim 1, further comprising:
when an enhanced Multimedia Broadcast/Multicast Service, eMBMS, of the second RAT function requires to transmit downlink subframes in the second RAT cell to an eMBMS UE in the updated MBSFN pattern, puncturing a CRS Port transmission that overlap with the eMBMS UE Resource Elements (REs), to avoid interference.

4. The method according to claim 1, wherein the transmitting in the second RAT cell, second RAT CRS on the at least one Port in the updated MBSFN pattern for the Cat-M UE to use, is performed in order to ensure Cat-M Channel Quality Information (CQI) and Channel Estimation, uninterrupted service, network synchronization.

5. The method according to claim 1, wherein the Cat-M UE is in extended- Discontinuous Reception (e-DRX), sleep.

6. The method according to claim 1, wherein the first RAT is represented by Fifth Generation New Radio, (5G NR), and the second RAT is represented by Long Term Evolution (LTE).

7. A computer program product comprising a non-transitory computer readable storage medium, having stored thereon a computer program comprising instructions, which when executed by processing circuitry, causes the processing circuitry to carry out the steps of the method according to claim 1.

8. (canceled)

9. A network node configured for handling a Category M (Cat-M), User Equipment (UE) in relation to a subframe configuration in a wireless communications network, which subframe configuration is adapted to be a Multicast-Broadcast Single-Frequency Network (MBSFN), subframe configuration configured for operating in a first Radio Access technology (RAT), and a second RAT, and which subframe configuration is adapted to comprise a first MBSFN pattern, the network node further being configured to:
configure a first RAT UE with the first MBSFN pattern and to perform rate-matching around at least one Cell-specific Reference Signal (CRS), Port of the second RAT in all subframes that are not part of the first MBSFN pattern,
broadcast information about the first MBSFN pattern in a second RAT cell, to a second RAT UE and the Cat-M UE which is of the second RAT,
when obtaining an updated subframe configuration comprising an updated MBSFN pattern:
refrain from broadcasting information about the updated MBSFN pattern to the Cat-M UE, and continue to broadcast information about the first MBSFN pattern in the second RAT cell to the Cat-M UE,
broadcast in the second RAT cell, information about the updated MBSFN pattern to the second UE, and
transmit in the second RAT cell, second RAT CRS on the at least one Port in the updated MBSFN pattern for the Cat-M UE to use.

10. The network node according to claim 9, further being configured to:
when an enhanced Multimedia Broadcast/Multicast Service, eMBMS, of the second RAT function requires to transmit downlink subframes in the second RAT cell to an eMBMS UE in the updated MBSFN pattern, puncture the eMBMS UE's Resource Elements (REs), that overlap with the at least one Port in the updated MBSFN pattern, to avoid interference.

11. The network node according to claim 9, further being configured to:
when an enhanced Multimedia Broadcast/Multicast Service, eMBMS, of the second RAT function requires to transmit downlink subframes in the second RAT cell to an eMBMS UE in the updated MBSFN pattern, puncture a CRS Port transmission that overlap with the eMBMS UE Resource Elements (REs), to avoid interference.

12. The network node according to claim 9, further being configured to transmit in the second RAT cell, the second RAT CRS on the at least one Port in the updated MBSFN pattern for the Cat-M UE to use, in order to ensure Cat-M Channel Quality Information (CQI), and Channel Estimation, uninterrupted service, network synchronization.

13. The network node according to claim 9, wherein the Cat-M UE is adapted to be in extended-- Discontinuous Reception (e-DRX), sleep.

14. The network node according to claim 9, wherein the first RAT is adapted to be represented by Fifth Generation New Radio (5GNR), and the second RAT is adapted to be represented by Long Term Evolution (LTE).
